(19) United States
(12) Patent Application Publication
(10) Pub. No.: US 2022/0098921 A1
(43) Pub. Date: Mar. 31, 2022

(54) EMERGENCY RESPONSE CABINET

(71) Applicant: Michael P. Madden, Howell, MI (US)

(72) Inventor: Michael P. Madden, Howell, MI (US)

(21) Appl. No.: 17/484,896

(22) Filed: Sep. 24, 2021

Related U.S. Application Data
(60) Provisional application No. 63/083,337, filed on Sep. 25, 2020.

(51) Int. Cl. E06B 3/44; A47B 81/00; A47B 67/02

(52) U.S. Cl. CPC E06B 3/443; E06B 3/4407; A47B 67/02; A47B 81/005

(57) ABSTRACT

An emergency response cabinet including a housing and a front door. The housing having opposing side walls, a bottom wall, a top wall and a rear wall cooperating to define a receiving cavity therein and a front opening. The receiving cavity being configured to receive at least one piece of protective equipment. The front door is connected to the housing and moveable between a closed position and an open position. In the closed position the front door extends over the receiving cavity of the housing. In the open position the receiving cavity is unobstructed by the front door.

### BACKGROUND

### 1. Field of the Invention

The present invention generally relates to an emergency response cabinet. More specifically, the invention relates to a storage device that conceals, but provide quick access to, body armor during an emergency situation, such as during a personal attack, home invasion or an active shooter situation.

### 2. Description of Related Technology

Various methods exists for the concealment of valuables. An in-wall mounted safe, covered by a picture or other object, may be the most well-known of these methods. Other methods also exist by providing a secret compartment that can be used to store the valuables in furniture. Such furniture methods include, without limitation, moveable (lifting or sliding) table tops, double bottomed drawers, hollow shelfs or mantels, concealed drawers and concealed doors.

In addition to their use for storage of valuables, these concealment methods have also been found to be useful for concealing firearms in the home, but keeping them readily available if a time of need ever arose.

### SUMMARY OF THE INVENTION

Emergency situations involving acts of violence against other persons can occur wherever a group of people is gathered. These acts of violence may and all too often involve weapons, such as knives and guns, and the locations are typically places of long considered typically safe and peaceful, such as schools, workplaces, stores, hospitals, places of worship and homes.

Having some form of personal protection from a stabbing, shooting or other act of violence greatly increases the likelihood that the protected person will survive the threat. One means of providing that protection is body armor, which is also known as a bullet proof vest. Not only does the body armor provides protection to the person wearing it, it allows the protected person to provide assistance and instruction to others, first aid to victims and, potentially, stopping of the threat, with a reduced risk of harm to themselves. Having the knowledge that one is protected, a person may be more willing to provide lifesaving assistance to others.

In order to have the ability to put on body armor, the body armor must be present in a location where the emergency situation may arise. However, in places like those mentioned above, having body armor physically in the open may not be psychologically conducive to the environment, its overall goals or purposes. Having the body armor in a closet or drawer, however, may render the obtaining and donning of the body armor during an emergency difficult or delayed.

With the above in mind, the present invention provides an emergency response cabinet that operates as a storage device to discreetly conceals the body armor, while also allowing for quick access to the body armor in an emergency situation.

Further objects, features and advantages of this invention will become readily apparent to persons skilled in the art after review of the following description with reference to the drawings and the claims that are appended to inform a part of this specification.

### BRIEF DESCRIPTION OF THE DRAWINGS

FIG. 1 is a perspective view of a storage device incorporating the principles of the present invention and shown with its door in a closed position.

FIG. 2 is a front view of the storage device seen in FIG. 1.

FIG. 3 is a view of the storage device seen in FIGS. 1 and 2 with the door in the open position providing access to body armor located therein.

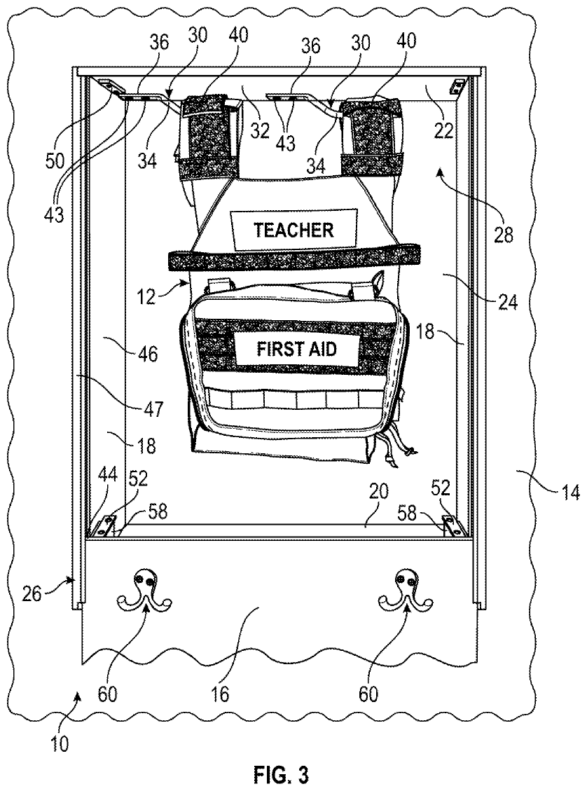

FIG. 4 is another view of the storage device of FIG. 3 with the door in the open position and body armor located therein.

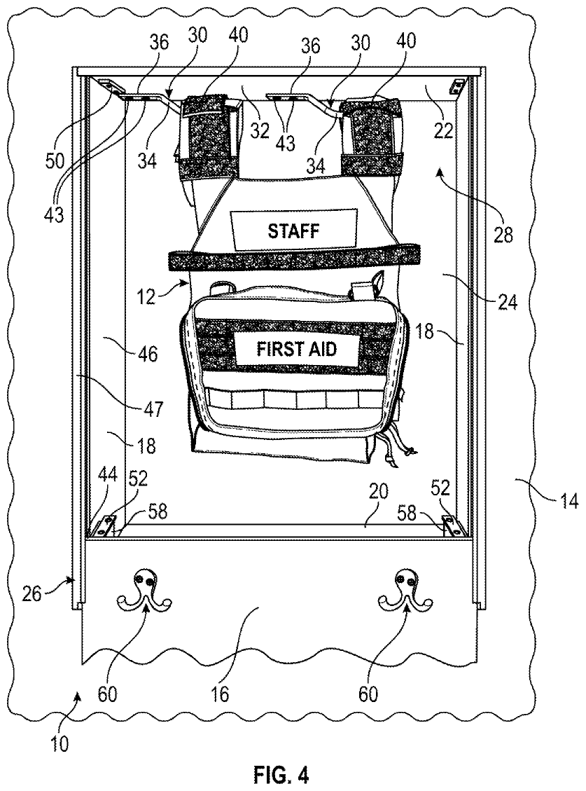

FIG. 5 is a further view of the storage device with the door in the open position and body armor located therein.

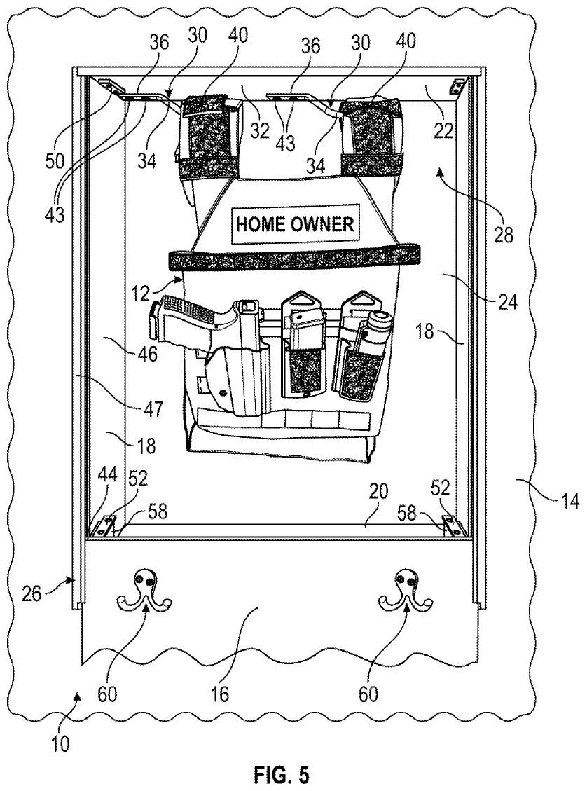

FIG. 6 is a view of storage or retention hooks located within the storage device for supporting the body armor within the storage device.

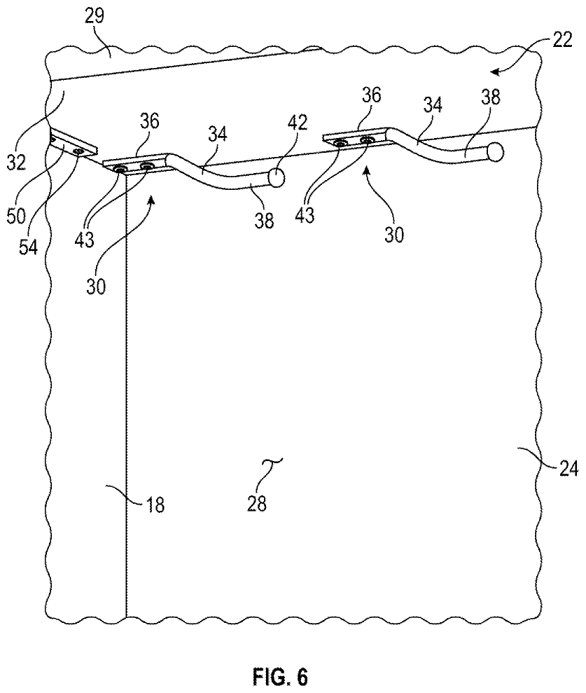

FIG. 7 is a side view of a magnet or magnetic catch and strike plate securing the door in the closed position.

FIG. 8 is a view of the upper interior of the storage device and shows the magnetic catch in relation to the groove, in which the door rides, and shown with the door in the open position.

FIG. 9 is a view of the lower interior of the storage device door and shows the door in the open position with the strike plate resting on a stop.

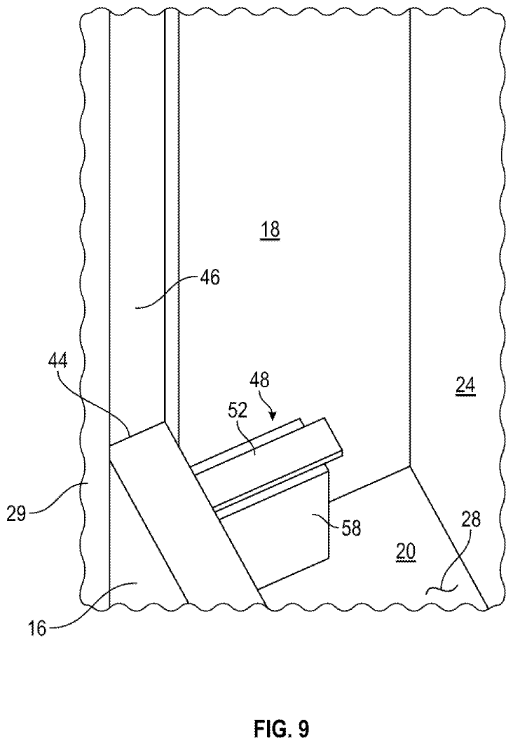

FIG. 10 is a side view of the door, strike plate and stop seen in FIG. 9.

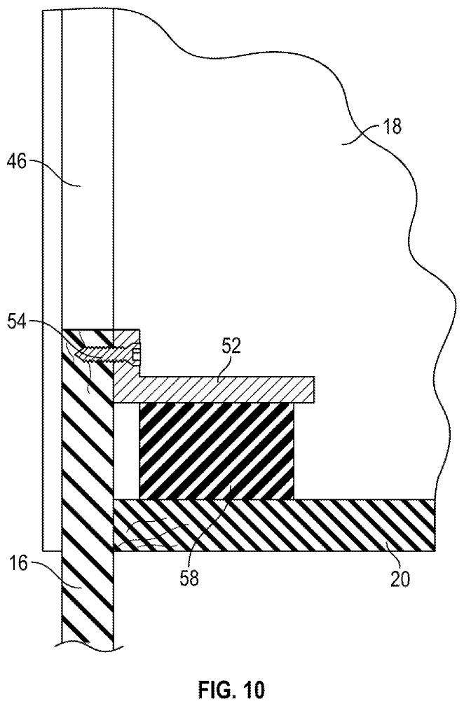

### DETAILED DESCRIPTION

Referring now to the figures, the present invention provides a storage device 10 that operates as an emergency response cabinet discreetly concealing protective equipment 12, such as body armor, while still allowing for quick and easy access to the protective equipment 12 in an emergency situation.

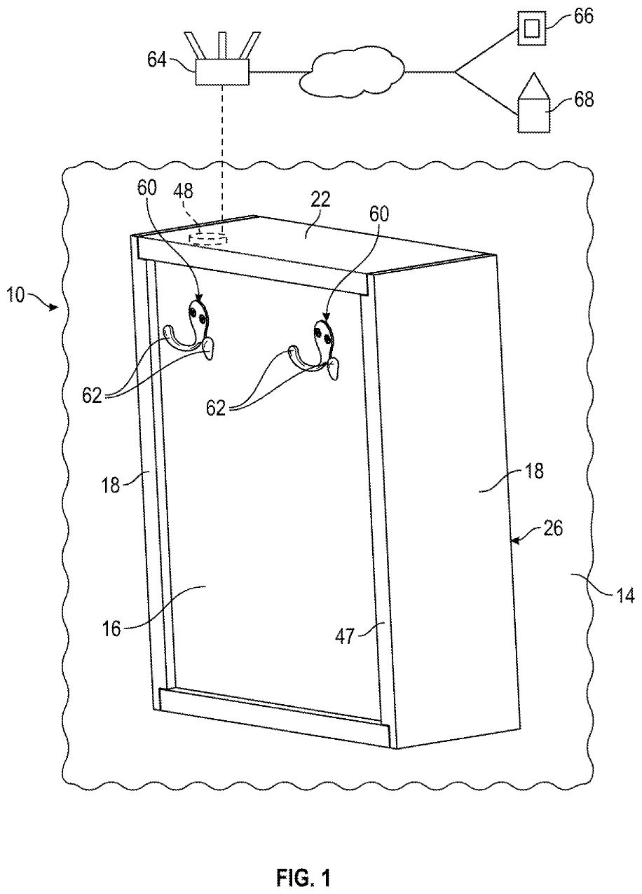

In broad terms, and as seen in FIG. 1, the storage device 10 is a cabinet or box (hereafter just “cabinet”) that is designed to hang on the wall 14 of a room, such as an office, classroom, bedroom or any other room. The front wall or door 16 of the cabinet 10 is designed to be easily and quickly opened in an emergency situation, providing ready access to the protective equipment 12, such as body armor, retained therein.

In one implementation, the cabinet 10 includes opposing side walls 18, opposing top and bottom walls 20, 22 and rear wall 24. The various walls 18, 20, 22, 24 are fixed to one another to form a housing 26 that defines the receiving cavity 28 that is open toward the front and in which the protective equipment 12 is stored.

The material forming the housing 26 may be one of variety of materials, including wood, metal, carbon fiber, plastic or another material, as long as the material is sufficiently strong and durable for the purposes and activities described herein.

To store the body armor 12 in the receiving cavity 28 of the housing 26, the protective equipment 12 may merely be placed within the receiving cavity 28 in “ready-to-don” position. However, it is preferred the housing 26 is provided with one or more hooks or hangers 30 within the receiving cavity 28 and upon which the protective equipment 12 may be hung.

In a preferred embodiment, two hangers 30 depend from the lower or inner surface 32 of the top wall 22. Also preferably, the hangers 30 are shaped and/or angled so that the body armor 12 can be easily removed from the hangers 30 without concern that any portion of the protective equipment 12 will get hung up on the hangers 30. As such, the specific shape and orientation of the hanger 30 may vary depending on the particular type of protective equipment 12.

For example, in the context of the protective equipment 12 being body armor 12, the hangers 30 may be in the form of single prong hooks 30 that extend via intermediate arm portions 34 initially downward away from a mounting plate 36 engaged with the inner surface 32 of the top wall 22, either perpendicular (vertically) or obliquely relative to the inner surface 32. Thereafter the hooks 30 may extend horizontally via terminal arm portions 38. In this preferred construction, length of the horizontal terminal arm portions 38 is such that the terminal arm portions 38 are able to extend under the shoulder straps 40 of the body armor 12 and that allow the body armor 12 to be removed from the housing 26 through the front opening simply by pulling the body armor 12 horizontally off of the hooks 30. The ends of the terminal arm portions 38 may be provided with small nubs 42 or other protrusions to assist in retaining the body armor 12 on the hooks 30. If so provided, however, the nubs 42 should be of a size and shape that aid in retaining the body armor 12 on the hooks 30, but do not obstruct or imped the removal of the body armor 12 from the hooks 30. As such, a preferred form for the nubs 42 would be rounded and extending above the upper surface of the terminal arm portion by a minimal amount, such as to ⅛^{th} inch.

The mounting plates 36 used to secure the hangers 30 to the top wall 22 by conventional means, such as threaded fasteners 43 appropriate for the material forming the housing 26. The hanger 30 may be oriented such that the terminal arm portions 38 extend parallel to the rear wall 24, as seen in the figures, or in a direction toward the front opening.

As mentioned above, the front wall or door 16 of the cabinet 10 is designed allow for quick and easy access to the interior receiving cavity 28 defined the housing 26. In a preferred construction, the front door 16 of the cabinet 10 opens downward. More specifically, the front door 16 is configured to slide downwardly when being opened. This configuration has several advantages. First, by sliding downwardly, the front door 16 minimizes the spaced needed in front of the cabinet 10 to open it and access its contents. Thus, the opening direction of the front door 16 does not extend or swing into the interior of the room, a direction perpendicular to the rear wall 24, in which it is located. Accordingly, activity in the room or in front of the cabinet 10 does not impede access to the cabinet 10 in an emergency. Additionally, by sliding downwardly, the weight of the front door 16 itself aids in opening the cabinet 10.

Any mechanism designed to allow the front door to slide downward, a direction generally perpendicular to the top wall 22, may be used. In one preferred construction, the lateral side edges 44 of the front door 16 are slidingly received within grooves 46 provided in the sidewalls 18. The grooves 46 extend along the length of the side wall 18, parallel to the rear wall 24, and are located adjacent to a forward or front edge 47 of the housing 26. As an alternative, mechanical sliding mechanisms, such as a drawer slide, may be used to mount the front door 16 to the housing 26.

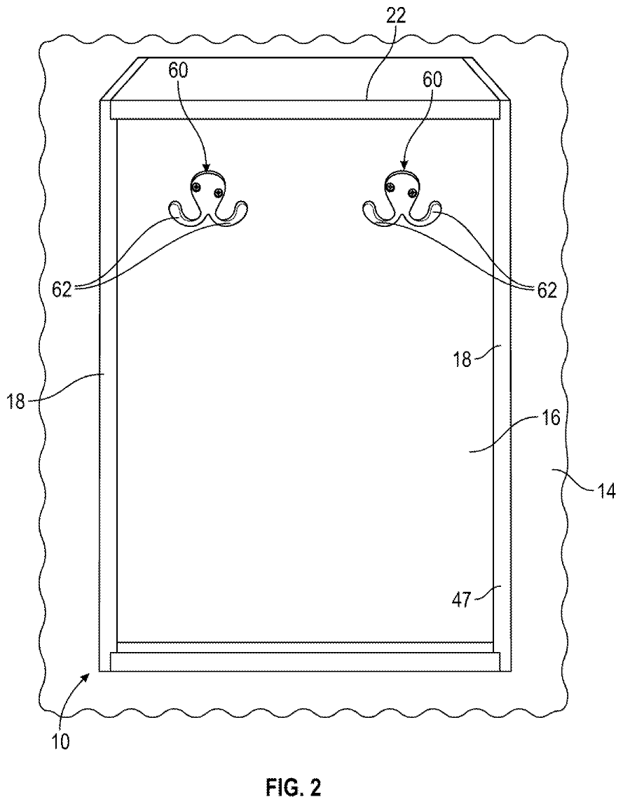

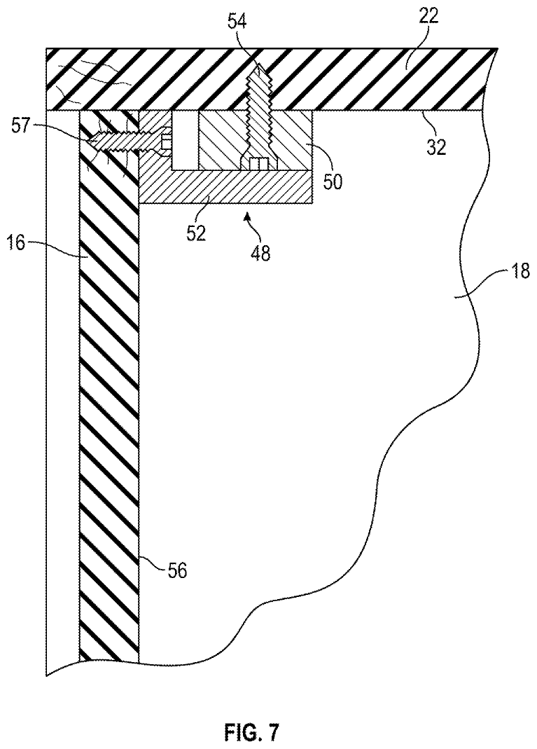

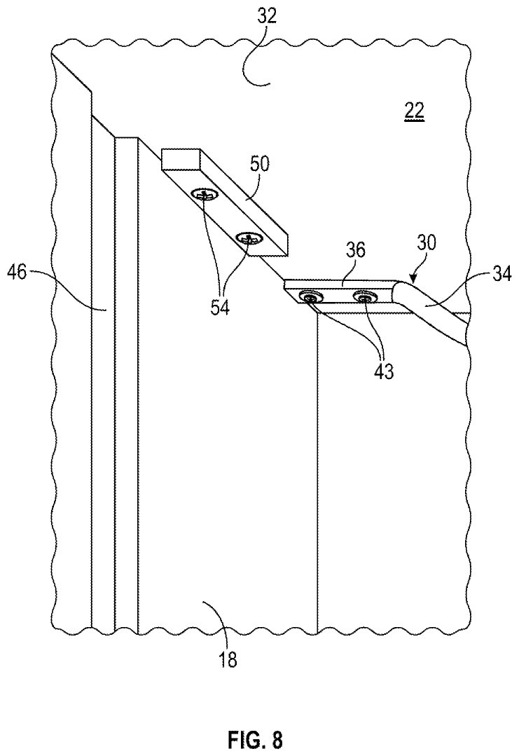

To secure the front door 16 in its closed (upward) position, quick releasing latches, handles or clasps may be used. In one preferred construction, the front door 16 is held in its closed position by one or more latch mechanisms 48 employing magnetic catches 50 and strike plates 52. Preferably, two latch mechanism 48 are employed, one mechanism near each upper corner of the front door 16, as seen in FIG. 2. 3-6 and particularly FIGS. 7 and 8,

Referring now to FIGS. 7 and 8, in one embodiment the magnetic catch 50 is simply provided as a magnet that is surface mounted to the inner surface 32 of the top wall 22, by threaded fasteners 54, inward of the front door 16. As shown, the strike plate 52 is provided as an L-bracket, formed from a ferromagnetic material (such as a metal, including steel and iron) and fastened to the inner surface 56 of the front door 16 by suitable fasteners 57. As seen in FIG. 7, the strike plate 52 is positioned on the front door 16 so that, when the front door 16 is in the closed position a rearwardly extending leg of the strike plate 52 interacts with the magnetic catch 50 and is retainingly engaged thereby, keeping the front door 16 in the closed positon. Alternatively, the magnetic catch 50 may be recessed into the inner surface 32 of the top wall 22, located immediately above the front door 16, generally in plane with the front door 16 and the grooves 46. In the latter instance, the strike plate 52 may be a plate mounted along the upper edge of the front door 16. Alternate and/or reverse locations for the catch 50 and strike plate 52 may also be employed, dependent on the formation and location of the strike plate 52 and catch 50.

To open the front door 16 of the cabinet 10 in an emergency situation, a person merely pulls downward on the front door 16 with a force sufficient to disengage the strike plate 52 from the magnetic catch 50. Once disengaged, the front door 16 may be lowered until the strike plates 52 engage the bottom wall 20 of the housing 26, thereby supporting and retaining the front door 16 with the housing 26. If desired, risers 58 may be provided on the bottom wall 20, or side walls 18, aligned with the strike plates 20. The risers 58 elevate the top of the front door 16 relative to the bottom wall 20, so as to prevent items from falling out of the cabinet 10. In lowering the front door 16, because the door 16 is retained with the cabinet 10, upon disengagement of the striker plates 52 from the magnetic catches 50, the door 16 may be released and let go, so as to drop under the influence of gravity, without worry of the front door 16 falling onto the floor. In this instance, the risers 58 engage the legs of the strike plate 52, receiving them on top of the risers 58, and operate as stops for the door 16, limiting its downward descent. The risers 58 may be formed of the same material as the housing 26 or may be provided as elastomeric stops so as to provide shock absorbency of the released front door 16.

In opening the front door 16, the front door 16 may include handles 60 that are easily grasped and pulled down to disengaging the magnetic catch 50 and latch 52. The handles 60 may serve other purposes. For example, the handles 60 may be provided in the form of dual prong hooks 62 on the exterior side of the front door 16. Provided as such the handles 60 may accommodate the hanging of jackets, purses, etc. and aid in masking the cabinet's real purpose and making it less obtrusive by blending with its environment.

The strength of the engagement between the magnetic catches 50 and striker plates 52 should be sufficiently strong so that the front door 16 is not inadvertently opened by the hanging of an article on the handles 60, but is still readily opened in an emergency. It is anticipated that the stretch of the interaction between the magnetic catches 50 and striker plates 52 is in the range of 15 to 50 lbs.

As an alternative to the magnetic latch mechanism 48 described above, the latch mechanism 48 may employ an electro-magnetic catch, electro-mechanical catch or other mechanism that is disengaged by a button, bio-metric sensor, RFID sensor or other actuator located on the cabinet 10. Additionally, the latch mechanism 48 may optionally be configured to wirelessly communicate via a local Wi-Fi or Bluetooth network 64 and enable disengagement of the latch via a software application resident on a remote device 66, such as a mobile phone, tablet or computer. Additionally, the cabinet 10 and/or latch mechanism 48 may optionally be configured to communicate with a status/building monitoring system 68, whereby the act of opening the cabinet 10 is communicated to persons responsible for building security/administration and/or to local public safety personnel.

The body armor may be any variety of protective equipment 12 and may be differently equipped depending on the particular location of the cabinet 10. For example, the protective equipment 12 may be body armor in the form of a bullet proof vest. The protective equipment 12 may also bear indicia indicating the status of the person wearing the protective equipment 12, such as “police,” “teacher,” “staff” or “homeowner.” The protective equipment 12 may also be equipped with various accessories or supplies, such as first aid supplies, self-defense spray, and/or a firearm and ammunition.

As a person skilled in the art will readily appreciate, the above description is only meant as an illustration of an implementation of the principles of the present invention. Accordingly, this description is not intended to limit the scope or application of this invention since the invention is susceptible to modification, variation and change, all without departing from the spirit of the invention, as defined in the following claims.

I claim:

1. An emergency response cabinet comprising:
a housing having by opposing side walls, a bottom wall, a top wall and a rear wall cooperating to define a receiving cavity therein and a front opening, the receiving cavity being configured to receive at least one piece of protective equipment therein;
a front door connected to the housing and being moveable between a closed position and an open position, in the closed position the front door extending over the receiving cavity of the housing, in the open position the receiving cavity being unobstructed by the front door.

2. The emergency response cabinet according to claim 1, wherein the front door is moveable in a direction parallel to the rear wall.

3. The emergency response cabinet according to claim 1, wherein in the open position the front door is parallel to the rear wall.

4. The emergency response cabinet according to claim 1, wherein the front door moves laterally relative to the housing between the closed position and the open positions.

5. The emergency response cabinet according to claim 1, wherein, with the rear wall in a vertical orientation, the front door moves downward from the closed position to the open position.

6. The emergency response cabinet according to claim 1, further comprising at least one latch having engaged and disengaged positions, in the engaged position the latch retaining the front door in the closed position.

7. The emergency response cabinet according to claim 6, wherein the latch includes a catch and a strike plate.

8. The emergency response cabinet according to claim 7, wherein the catch is a magnetic catch and the strike plate is a ferromagnetic material.

9. The emergency response cabinet according to claim 7, wherein the catch is mounted to the housing and the strike plate is mounted to the front door.

10. The emergency response cabinet according to claim 6, wherein the latch is mounted between the top wall and the front door.

11. The emergency response cabinet according to claim 6, wherein the latch is mounted between the front door and the housing.

12. The emergency response cabinet according to claim 6, wherein the latch is configured to communicate via a local wireless network for at least one of moving the front door to the open position via activation by a remote device or communicating movement of the front to the open position to a status monitoring system.

13. The emergency response cabinet according to claim 1, wherein the housing includes a groove in each of the opposing side walls and the front door include opposing side edges, the opposing side edges being received within the grooves, whereby the door is slidably received within the grooves.

14. The emergency response cabinet according to claim 13, wherein the side walls have a length and a width, the grooves extending in a lengthwise direction along the side walls.

15. The emergency response cabinet according to claim 1, further comprising a stop, a portion of the front door configured to interact with the stop and define the open position of the front door.

16. The emergency response cabinet according to claim 15, wherein stop is mounted to the housing and the portion of the front door extends from the front door into the housing, the portion of the front door being aligned with the stop and engaging the stop in the open position.

17. The emergency response cabinet according to claim 15, wherein the portion of the door is part of a latch, the latch being configured to retain the door in the closed position.

18. The emergency response cabinet according to claim 1, further comprising a retaining member provided within the receiving cavity and configured to receive the piece of protective equipment thereon.

19. The emergency response cabinet according to claim 18, wherein the retaining member is a hanger, the hanger including a terminal portion extending substantially parallel to the top wall.

20. The emergency response cabinet according to claim 18, wherein the retaining member includes a pair of hangers.
